(19) United States
(12) Patent Application Publication
(10) Pub. No.: US 2015/0379782 A1
(43) Pub. Date: Dec. 31, 2015

(54) METHOD OF AUTOMATICALLY ADJUSTING TOLL COLLECTION INFORMATION BASED ON A NUMBER OF OCCUPANTS IN A VEHICLE

(71) Applicant: Alpine Electronics, Inc., Tokyo (JP)

(72) Inventor: Atsushi Nakagawa, Torrance, CA (US)

(73) Assignee: Alpine Electronics, Inc.

(21) Appl. No.: 14/316,488

(22) Filed: Jun. 26, 2014

(51) Int. Cl. G07B 15/06

(52) U.S. Cl. CPC G07B 15/063

(57) ABSTRACT

A method of communicating information regarding a number of occupants in a vehicle for an electronic toll collection system having an antenna at a toll lane entrance, the vehicle and a transponder in the vehicle, includes detecting occupancy in the vehicle by at least one sensor in the vehicle, computing a number of one or more occupants based on the detected occupancy by the at least one sensor, setting one of a plurality of toll configurations based on the number of one or more occupants, transmitting the one of the plurality of toll configurations and account information associated with the transponder to the antenna, receiving the one of the plurality of toll configurations and the account information from the transponder, and charging a predetermined toll amount on an account corresponding to the received account information based on the one of the plurality of toll configurations from the transponder.

### BACKGROUND

1. Field

The present disclosure relates to a method and system of automatically adjusting toll collection information based on a number of occupants in a vehicle. More specifically, embodiments in the present disclosure relate to a method and system of automatically adjusting toll collection information based on a number of occupants in a vehicle such that the number of occupants in the vehicle can be automatically detected and a status related to the number of occupants is updated based on the detection and the status is notified to a toll collection system so that a driver is properly charged or exempted to be charged at a toll road.

2. Description of the Related Art

Various types of electronic toll collection (ETC) systems with electronically wireless payment have been widely introduced. This type of systems aim at reducing delays on toll road by automatic payment without stopping at toll plaza, booths or gates while allowing users electronic payment without cash. This type of payment may be executed with an electronic toll collection (ETC) equipment installed on lanes at a toll plaza which communicates electronically with a toll tag including a transponder. The ETC equipment reads toll tag information and a number of axles on a tolled vehicle. The read information and a time, date, and location are collected to automatically deduct a correct toll amount from the user's prepaid account balance or the user's credit card or bank account.

Frequently the system charges tolls for accessing a special road (e.g. motorway, bypass), a bridge, a tunnel, etc. In addition, programs of congestion pricing by converting High Occupancy Vehicle (HOV) to High Occupancy Toll (HOT) lanes with pricing differing by a number of occupants in a vehicle has been introduced. On these HOT lanes, a user is required to transmit the information related to the number of occupants via the transponder whether a user is a solo driver or carpool, so that an appropriate amount will be charged for the number of occupants. In a conventional ETC system, a tag including a transponder available for a user is equipped with a switch for indicating a carpool status. One of the conventional ETC tag as illustrated in FIG. 10(a) merely allows a user to switch between HOV status OFF 1001 and HOV status ON 1002 of the toll configuration indicator 1000. Another conventional ETC tag as illustrated in FIG. 12(a) merely allows a user to switch among HOV status OFF 1201, HOV 2 status 1202 for indicating two occupants in a vehicle and HOV 3+ status 1203 for indicating three or more occupants in the vehicle, of the toll configuration indicator 1200. These tags require the user to adjust a switch according to the number of occupants in order to transmit a correct HOV status to the ETC system. However, this switching is cumbersome and the user may tend to forget. The ETC equipment also includes a camera which may capture the vehicle's license plate and photographs of the vehicle including occupants. If a tag is not read or the information related to HOV status is incorrect, the license plate image will be used to send a violation notice to the vehicle's registered owner. The violation notice includes a fee in addition to the toll that is owed. Highway patrol may also assist with the enforcement of toll collection on express lanes and at bridges. To detect violation of toll road usage, some toll roads may have “automated” toll enforcement systems that take photographs of drivers who do not pay the tolls and their license plates and typically send the toll bill along with a fine at a later time.

To avoid such violation, there have been several solutions proposed. For example, U.S. Pat. No. 7,786,897 B2 suggests an HOV enforcement system having roadside imaging units online. However, cameras on roadside may be defective, especially detecting passengers with a relatively low height which results in an unfavorable result for the user. In US 2010/0201505 A1, a personal nomadic communicator (PNC) to declare a number of passengers was suggested. However, this type of systems disregards a current ETC system infrastructure and the system still relies on detection of locations and moving patterns of PNCs. It is not guaranteed whether a number of passengers and a number of PNCs correspond with each other because some occupants may have a plurality of PNCs while some occupants may have none. In US 2012/0143786, using a Doppler radar or UWB impulse radar may be used for occupants detection. However, these radar systems are not readily available in an ordinary vehicle. By using a weight sensor, the user may disguise loading passengers by loading things. Thus more accurate detection method for transmission of HOV status is required.

Accordingly, there is a need to provide a method and system that allows a tag including a transponder to easily transmit an automatically and accurately detected HOV status of the vehicle without a user operation which enables the ETC system to accurately charge an appropriate amount for the number of occupants for using a carpool lane of a toll road.

### SUMMARY

In one aspect, a method of communicating information regarding a number of occupants in a vehicle for an electronic toll collection system is provided. The electronic toll collection system includes at least one antenna at a toll lane entrance and a transponder in the vehicle. This method includes detecting occupancy in the vehicle by at least one sensor in the vehicle, computing a number of one or more occupants based on the detected occupancy by the at least one sensor, setting one of a plurality of toll configurations based on the number of one or more occupants in the vehicle. The transponder transmits the one of the plurality of toll configurations and account information associated with the transponder to the antenna. At the toll lane entrance, the one of the plurality of toll configurations and the account information is received from the transponder, and a predetermined toll amount is charged on an account corresponding to the received account information based on the one of the plurality of toll configurations from the transponder.

In one embodiment, the method uses an electric field sensor, a seat belt sensor or a combination thereof as at least once sensor in the vehicle.

In another aspect, an electronic toll collection system that sets a toll configuration based on a number of one or more occupants in a vehicle is provided. In the electronic toll collection system, a transponder in the vehicle sets one of a plurality of toll configurations corresponding with the number of one or more occupants and transmits the one of the plurality of toll configurations and account information associated with the transponder to the antenna. At an entrance of a toll lane, one or more antennas receive the one of the plurality of toll configurations and the account information from the transponder. The electronic toll collection system further includes at least one sensor in the vehicle that detects occupancy in the vehicle, and a processor that computes the number of one or more occupants based on the detected occupancy by the at least one sensor.

In one embodiment, the at least one sensor is an electric field sensor, a seat belt sensor or a combination thereof.

In one embodiment, the transponder may include the processor therein. In another embodiment, the transponder is coupled to the processor via a vehicle bus. In another embodiment, the transponder is wirelessly coupled to the processor.

In one embodiment, the at least one sensor is coupled to the transponder via a vehicle bus. In another embodiment, the at least one sensor is wirelessly coupled to the transponder.

In one embodiment, the at least one sensor is coupled to the processor via a vehicle bus. In another embodiment, the at least one sensor is wirelessly coupled to the processor.

In another aspect, a transponder in a vehicle for an electronic toll collection system that sets a toll configuration based on a number of one or more occupants is provided. The transponder sets one of a plurality of toll configurations corresponding with a number of one or more occupants and transmits the one of the plurality of toll configurations and account information associated with the transponder to the antenna. The transponder receives the number of one or more occupants from a processor as a result of computation based on the detected occupancy by at least one sensor in the vehicle.

The above and other aspects, objects and advantages may best be understood from the following detailed discussion of the embodiments.

### BRIEF DESCRIPTION OF THE DRAWINGS

FIG. 1 is a schematic overview of an electronic toll collection (ETC) system, including a toll collection information receiver and a toll collection information tag equipped in a vehicle, according to some embodiments of the invention.

FIG. 2 is a block diagram of a toll collection information reporting device and peripheral devices, where a transponder is outside of the toll collection information reporting device, according to some embodiments of the invention.

FIG. 3 is a block diagram of a toll collection information reporting device, where a transponder is integrated in the toll collection information reporting device, according to some embodiments of the invention.

FIG. 4 is a block diagram of a toll collection information reporting device, where a number of sensors are coupled to the toll collection information reporting device for calculation of a number of occupants, according to some embodiments of the invention.

FIG. 5 shows an interior of a vehicle equipped with some embodiments of a toll collection information reporting device where sensors and a transponder are coupled to the toll collection information reporting device connected via a vehicle bus.

FIG. 6 shows an interior of a vehicle equipped with some embodiments of a toll collection information reporting device where sensors are wirelessly coupled to the toll collection information reporting device and a transponder is integrated in the toll collection information reporting device.

FIG. 7 is a flow chart determining a condition of starting detecting occupants, according to one embodiment.

FIG. 8 is a flow chart determining a condition of confirming detecting occupants, according to one embodiment.

FIG. 9 is a flow chart determining an HOV status whether a carpool mode is activated after confirming detecting or not detecting occupants, according to one embodiment.

FIG. 10 is a schematic diagram of HOV status indicators. Two switches (a) on left show conventional systems and two indicators (b) on right show the HOV status indicators according to one embodiment.

FIG. 11 is a flow chart determining an HOV status whether a carpool mode is activated and what HOV status is to be chosen after confirming a number of detected occupants, according to one embodiment.

FIG. 12 is a schematic diagram of HOV status indicators. Three switches (a) on left show conventional systems and three indicators (b) on right show the HOV status indicators according to one embodiment.

### DETAILED DESCRIPTION OF THE PREFERRED EMBODIMENTS

Various embodiments for the method and system of sharing a broadcast preset table between a vehicle tuner and an external device will be described hereinafter with reference to the accompanying drawings. Unless defined otherwise, all technical and scientific terms used herein have the same meaning as commonly understood to one of ordinary skill in the art to which present disclosure belongs. Although the description will be made mainly for the case where the method and system of automatically adjusting toll collection information based on a number of occupants in a vehicle, any methods, devices and materials similar or equivalent to those described, can be used in the practice or testing of the embodiments. All publications mentioned are incorporated by reference for the purpose of describing and disclosing, for example, the designs and methodologies that are described in the publications which might be used in connection with the presently described embodiments. The publications listed or discussed above, below and throughout the text are provided solely for their disclosure prior to the filing date of the present disclosure. Nothing herein is to be construed as an admission that the inventors are not entitled to antedate such disclosure by virtue of prior publications.

In general, various embodiments of the present disclosure are related to a method and system of automatically adjusting toll collection information based on a number of occupants in a vehicle. Furthermore, the embodiments are related to a device, e.g. transponder, of transmitting passenger information based on a number of occupants in a vehicle for automatically adjusting toll collection information.

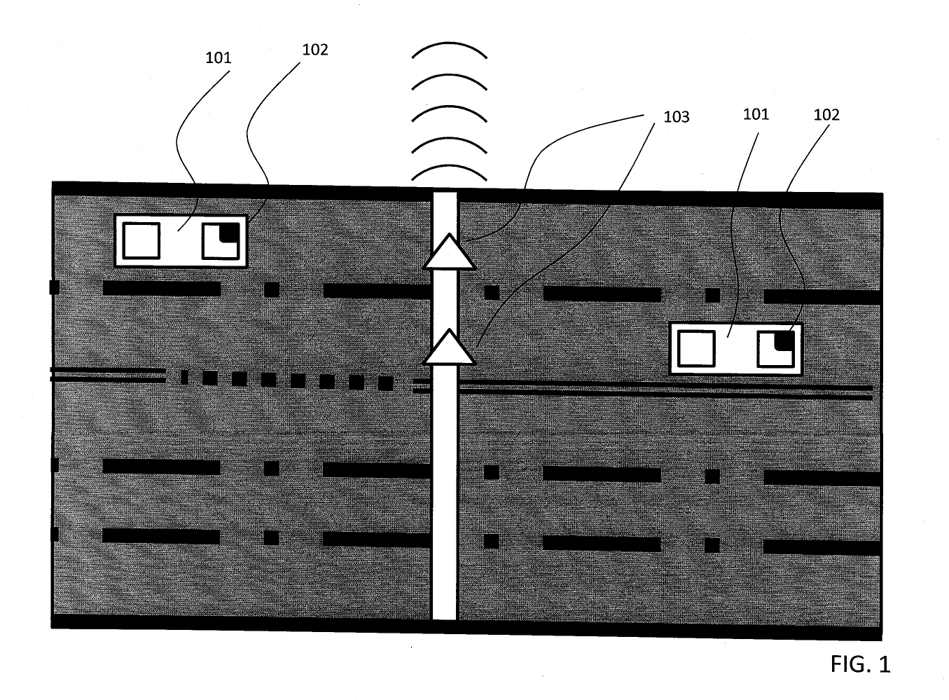

FIG. 1 is a schematic diagram of a vehicle equipped with a toll collection information reporting system that executes automatically adjustment of toll collection information based on a number of occupants in a vehicle and a toll collection information receiving device equipped at a toll road according to one embodiment. The various embodiments can be applied to other type of toll collection information reporting system. For example, a vehicle 101 is equipped with a toll collection information reporting device 102 for automatically adjusting toll collection information based on a number of occupants in the vehicle 101. Once a signal including data of adjusted toll collection information is transmitted from the toll collection information reporting device 102, a toll collection information receiver 103 equipped at a toll road, typically at an entrance but not limited to that, receives the signal and the adjusted toll collection information is further processed at a conventional toll collection server.

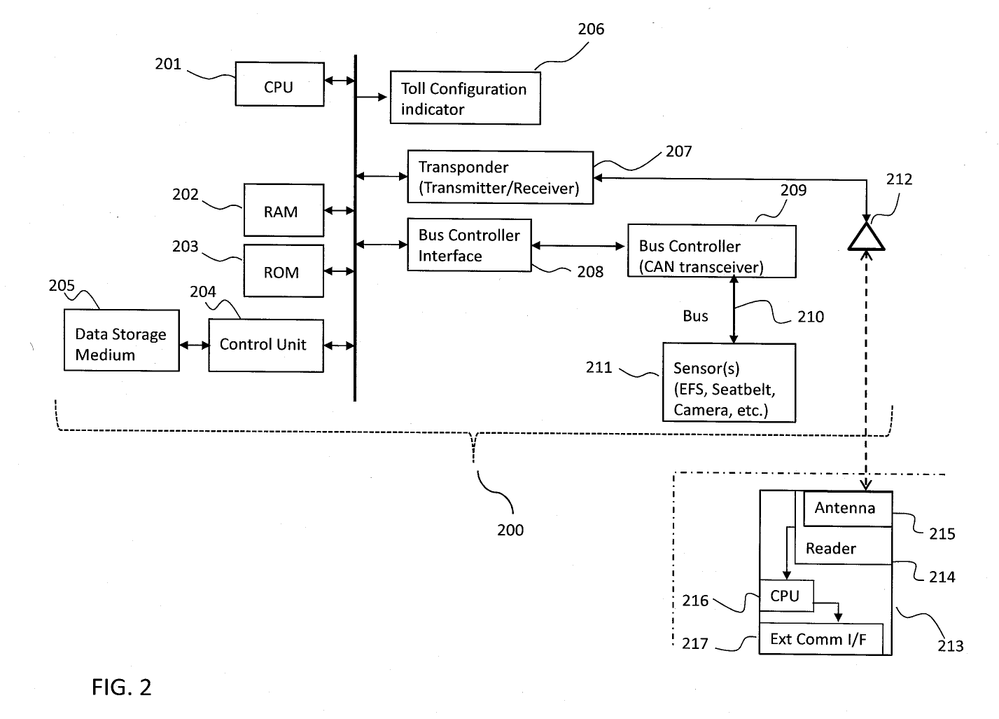

FIG. 2 is a block diagram of the toll collection information reporting system in a vehicle 200 according to one embodiment. Note that the schematic diagram in FIG. 2 is merely an example according to one embodiment for an illustration purpose and not intended to represent any one particular architectural arrangement. For example, the vehicle 200 includes a central processor unit (CPU) 201 for controlling an overall operation of the vehicle, random access memory (RAM) 202 for storing a processing result, and read only memory (ROM) 203 for storing various control programs, such as a vehicle operation program and a driver alert control program, necessary for vehicle control as well as a in-vehicle status detection and handling of this disclosure.

The vehicle 200 may also include a data storage medium 205 such as a hard disk in a hard disk drive (HDD), flash memory in a solid state drive (SSD) or universal serial bus (USB) key memory, a compact disc-read only memory (CD-ROM), a digital versatile disc (DVD) or other storage medium that may store geographical information for map and route guidance and entertainment contents such as music, video etc. The vehicle may also include a control unit 204 for controlling an operation for reading the information from the data storage medium 205. The vehicle 200 may have a toll configuration indicator 206 which indicates a current vehicle configuration status for toll collection, such as a number of occupants in a vehicle, a vehicle is whether commercial or noncommercial, a weight or size of a vehicle, etc., whatever factor which may cause adjustment of toll collection. The vehicle 200 may include one or more sensors 211 for sensing a number of occupants. The one or more sensors may be weight sensors, body temperature thermometers, or seat belt sensors such as seat belt buckle sensors or seat belt tension sensors associated with each seat belt provided for each seat in the vehicle for sensing whether the seat belt is fastened, or any sensor which is available to detect existence of an occupant. Alternatively, cameras for monitoring occupants in the vehicle, proximity sensors for detecting existence of an occupant nearby, such as heart pulse sensors, electric field sensors may be applied for this purpose. In particular, electric field sensors or body temperature thermometers may be preferred for accuracy of occupant detection. Data from the sensors 211 are transmitted via a bus 210 controlled by a bus controller interface 208. The bus 210 may be either wireless or wired, such as a Controller Area Network (CAN) bus, a Local Interconnect Network (LIN) bus, or others. The vehicle 200 may also include a transponder 207 which wirelessly communicates with an external device such as a toll collection information receiver 213 via an antenna module 212 and transmits the current vehicle configuration status for toll collection to the toll collection information receiver 213. For example, the transponder 207 may include, but not limited to, a radio frequency Identification (RFID) tag of ultra high frequency (UHF) band signals whereas the toll collection information receiver 213 may include an RFID reader 214, and the transponder 207 and the toll collection information receiver 213 communicates with each other using a frequency band such as an ultra-high frequency (UHF) band of approximately 900 MHz. The toll collection information receiver 213 receives the current vehicle configuration status for toll collection at the RFID reader 214 via the reader's antenna 215 and the status is processed at a CPU 216 and the toll collection information is forwarded to a back end server for processing toll collection via an external communication interface 217, either wirelessly or with wire, together with vehicle identification information collected in the current vehicle configuration status combined with or without extra vehicle information obtained at the reader 214, by reading the vehicle's license plate etc., for instance.

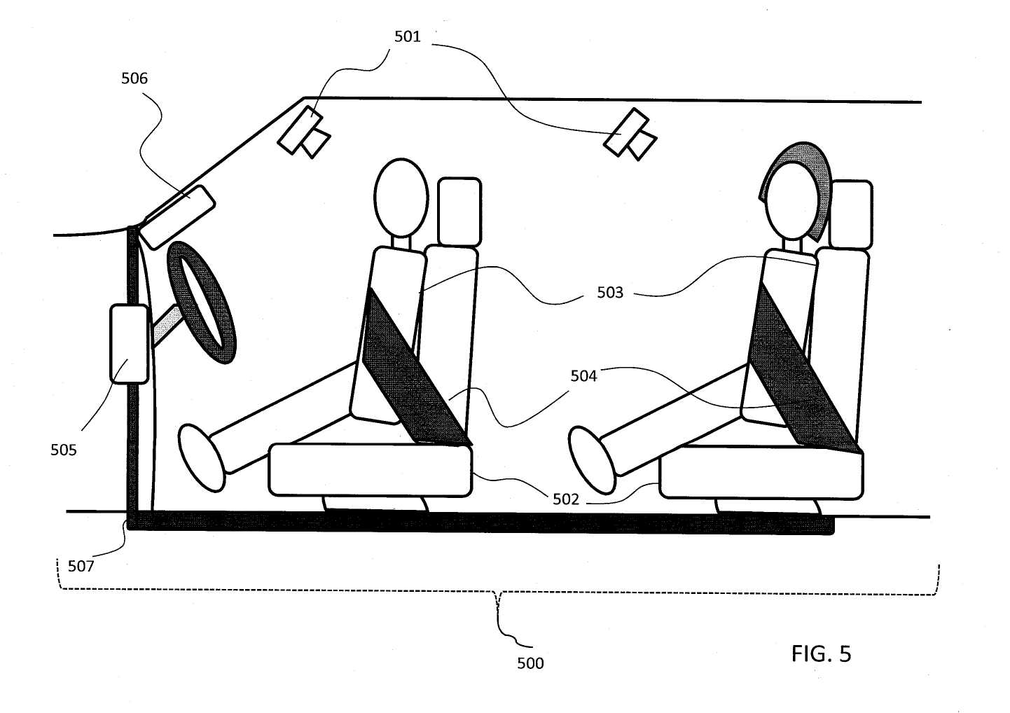

FIG. 5 is an illustrative diagram of the embodiment shown in the block diagram of FIG. 2. FIG. 5 is the illustrative diagram of the toll collection information reporting system in a vehicle 500 according to one embodiment. Note that the illustrative diagram in FIG. 5 is merely an example according to one embodiment for an illustration purpose and not intended to represent any on particular architectural arrangement. For example, the vehicle 500 may include sensors for detecting occupants. For example, the sensors may be one or more cameras 501 for monitoring behavior of occupants in the vehicle. Alternatively, the sensors may be one or more weight sensors 502 for detecting occupants by weighing the occupants, seat by seat. Other sensors may be one or more proximity sensors 503 for detecting existence of an occupant nearby. Each proximity sensor 503 may be a heart pulse sensor, an electric field sensor, or a body temperature thermometer sensing body temperature of an occupant. Alternatively, the vehicle 500 may be equipped with one or more seat belt sensors 504 for detecting whether the seat belt by each occupant is fastened. The seat sensors can be by detecting tensions of seat belts or detecting the seat belts buckling status at switches at buckles. The sensors listed here merely are examples, and any sensor capable of detecting existence of a human body may be applied for this purpose.

The vehicle 500 also includes a control unit 505 for controlling an overall operation of the vehicle 500. The control unit 505 is coupled to one or more sensors such as the cameras 501, the weight sensors 502, the proximity sensors 503, and the seat belt sensors 504 via a vehicle bus 507. The vehicle bus may be either a Controller Area Network (CAN) bus, a Local Interconnect Network (LIN) bus, or others. Data from the sensors are collected at the control unit 505 via the vehicle bus 507 and the control unit 505 processes the sensor data and calculates a current vehicle configuration status for toll collection, such as a number of occupants in a vehicle, a vehicle is whether commercial or noncommercial, a weight or size of a vehicle, etc. The control unit 505 is also coupled to a transponder 506 via the vehicle bus 507 or wirelessly via Bluetooth, wifi, etc. The control unit 505 transmits the calculated current vehicle configuration status for toll collection to the transponder 506, and the transponder 507 transmits the current vehicle configuration status for toll collection to a toll collection information receiver.

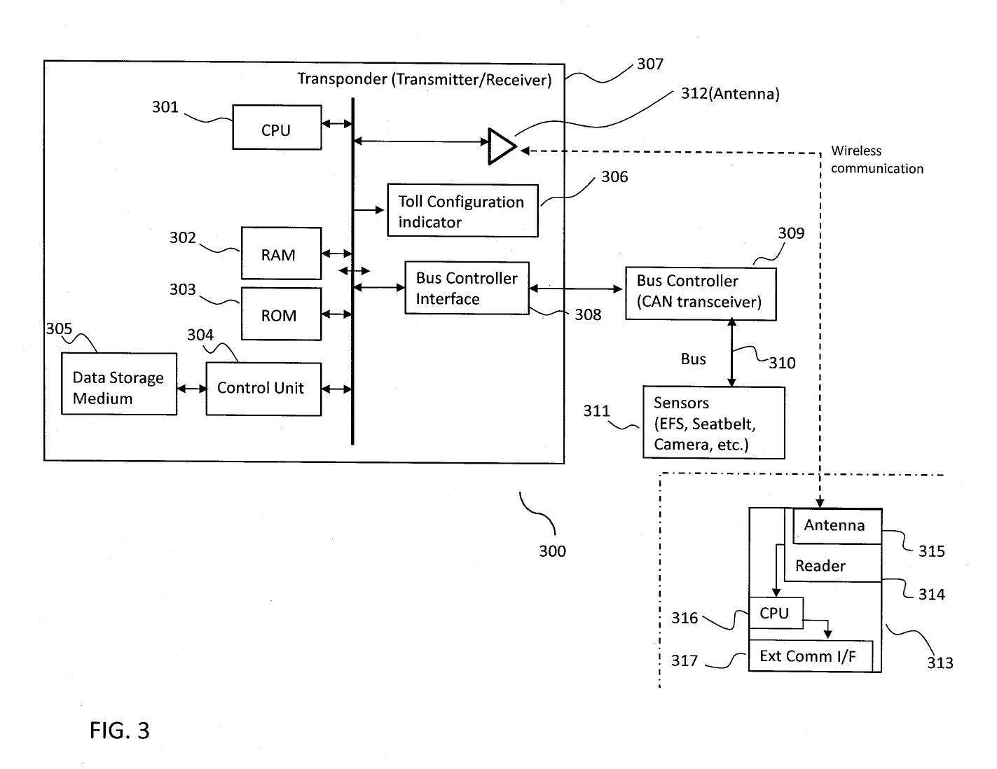

In according to another embodiment, FIG. 3 is a block diagram of a transponder 307 in a vehicle 300 for an electronic toll collection system. Note that the schematic diagram in FIG. 3 is merely an example according to one embodiment for an illustration purpose and not intended to represent any on particular architectural arrangement. For example, the transponder 307 includes a CPU 301 for controlling an overall operation of the vehicle, RAM 302 for storing a processing result, and ROM 303 for storing various control programs, such as a vehicle operation program and a driver alert control program, necessary for vehicle control as well as an in-vehicle status detection and handling of this disclosure.

The transponder 307 may also include a data storage medium 305 such as a hard disk in a HDD, flash memory in a SSD or USB key memory, a CD-ROM, a DVD or other storage medium that may store geographical information for map and route guidance and entertainment contents such as music, video etc. The vehicle may also include a control unit 304 for controlling an operation for reading the information from the data storage medium 305. The transponder 307 may include a bus controller interface 308. The bus controller interface 308 controls transmission of data related to occupants detection from one or more sensors 311 via a bus 310. The bus 310 may be either wireless or wired, such as a Controller Area Network (CAN) bus, a Local Interconnect Network (LIN) bus, or others. The transponder 307 may have a toll configuration indicator 306 which indicates a current vehicle configuration status for toll collection, such as a number of passengers in a vehicle based on occupants detection at the one or more sensors 311, a vehicle is whether commercial or noncommercial, a weight or size of a vehicle, etc., whatever factor which may cause adjustment of toll collection. The transponder 307 wirelessly communicates with an external device such as a toll collection information receiver 313 via an antenna module 312 and transmits the current vehicle configuration status for toll collection to the toll collection information receiver 313. The toll collection information receiver 313 receives the current vehicle configuration status for toll collection at a reader 314 via its antenna 315 and the status is processed at a CPU 316 and the toll collection information is forwarded to a back end server for processing toll collection via an external communication interface 317, either wirelessly or with wire, together with vehicle identification information collected in the current vehicle configuration status combined with or without extra vehicle information obtained at the reader 314, by reading the vehicle's license plate etc., for instance.

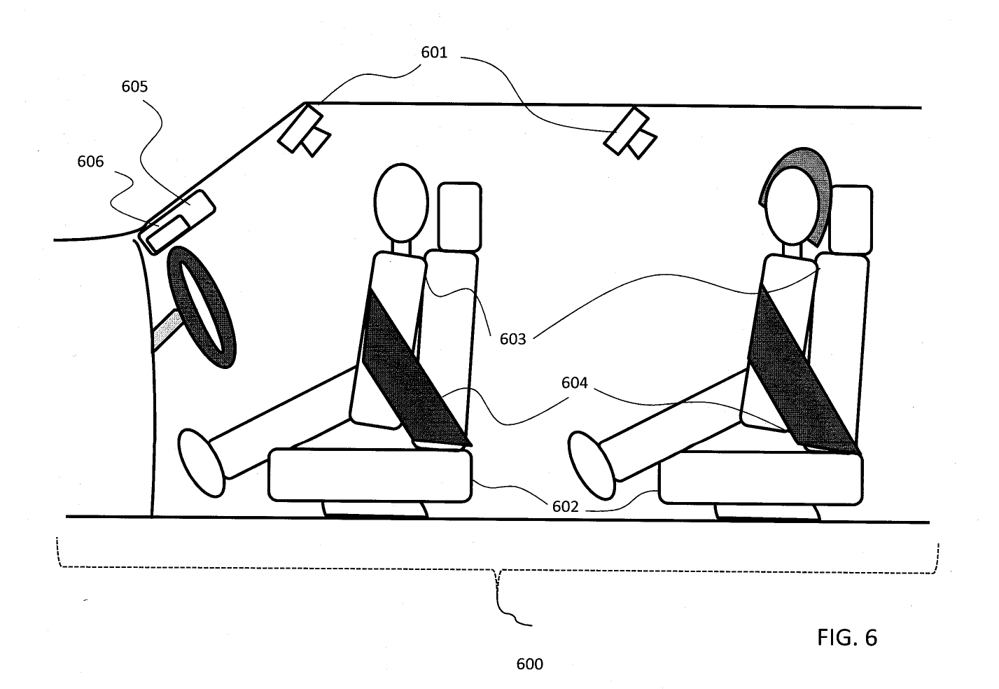

FIG. 6 is an illustrative diagram of the embodiment shown in the block diagram of FIG. 3. FIG. 6 is the illustrative diagram of the toll collection information reporting system in a vehicle 600 according to one embodiment. Note that the illustrative diagram in FIG. 6 is merely an example according to one embodiment for an illustration purpose and not intended to represent any on particular architectural arrangement. For example, the vehicle 600 may include sensors for detecting occupants. For example, the sensors may be one or more cameras 601 for monitoring behavior of occupants in the vehicle. Alternatively, the sensors may be one or more weight sensors 602 for detecting occupants by weighing the occupants, seat by seat. Other sensors may be one or more proximity sensors 603 for detecting existence of an occupant nearby. Each proximity sensor 603 may be a heart pulse sensor, an electric field sensor, or a body temperature thermometer sensing body temperature of an occupant. Alternatively, the vehicle 600 may be equipped with one or more seat belt sensors 604 for detecting whether the seat belt by each occupant is fastened. The seat sensors can be by detecting tensions of seat belts or detecting the seat belts buckling status at switches at buckles. The sensors listed here merely are examples, and any sensor capable of detecting existence of a human body may be applied for this purpose.

The vehicle 600 also includes a control unit 605 for controlling an overall operation of the vehicle 600 which includes a transponder 606 therein. The control unit 605 is coupled to one or more sensors such as the cameras 601, the weight sensors 602, the proximity sensors 603, and the seat belt sensors 604 wirelessly. The wireless communication may be Bluetooth, wifi, etc. Data from the sensors are wirelessly collected at the control unit 605 and the control unit 605 processes the sensor data and calculates a current vehicle configuration status for toll collection, such as a number of occupants in a vehicle, a vehicle is whether commercial or noncommercial, a weight or size of a vehicle, etc. The control unit 605 transmits the calculated current vehicle configuration status for toll collection via the transponder 606 to a toll collection information receiver.

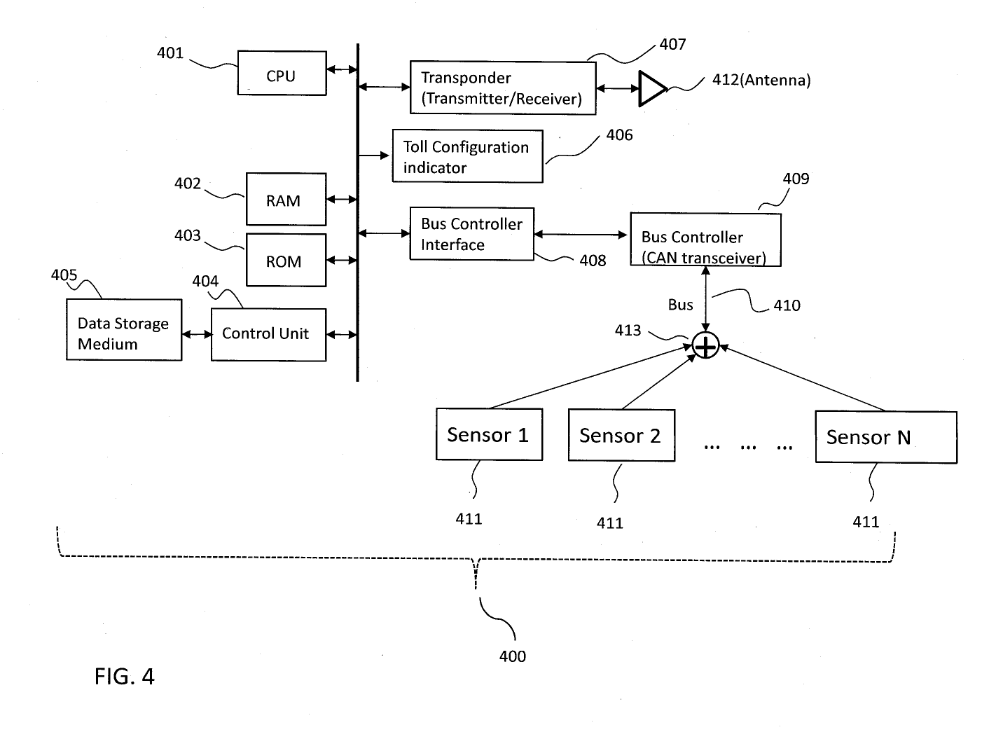

According to one embodiment, a number of occupants may be detected by a plurality of sensors included in a toll collection information reporting system in a vehicle and FIG. 4 is a block diagram of the toll collection information reporting system integrated in a vehicle. Note that the schematic diagram in FIG. 4 is merely an example according to one embodiment for an illustration purpose and not intended to represent any on particular architectural arrangement. Similarly to FIG. 2, the vehicle 400 may include a CPU 401, RAM 402, ROM 403, a data storage medium 405 and a control unit 404 as a data storage medium controller. The vehicle may also include a toll configuration indicator 406 which indicates a current vehicle configuration status for toll collection, such as a number of passengers in a vehicle, a vehicle is whether commercial or noncommercial, a weight or size of a vehicle, etc., whatever factor which may cause adjustment of toll collection and a transponder 407 which wirelessly communicates with an external device such as a toll collection information receiver via an antenna module 412 and transmits the current vehicle configuration status for toll collection to the toll collection information receiver. In this embodiment, it is possible to detect the current vehicle configuration status for toll collection by employing a plurality of sensors 411.

In one embodiment, the current vehicle configuration status for toll collection related to the number of passengers in the vehicle may be obtained by a plurality of sensors 411. The plurality of sensors 411 equipped with each seat may be weight sensors, body temperature thermometers, or seat belt sensors such as seat belt buckle sensors or seat belt tension sensors associated with each seat belt provided for each seat in the vehicle for sensing whether the seat belt is fastened, or any sensor which is available to detect existence of an occupant. Alternatively, cameras for monitoring occupants in the vehicle, proximity sensors for detecting existence of an occupant nearby, such as heart pulse sensors, electric field sensors may be applied for this purpose. Each of the plurality of sensors 411 detects seat occupancy information whether seat occupancy is detected (e.g. signal=“1”) or undetected (e.g. signal=“0”) and the plurality pieces of the seat occupancy information are combined at an adder 413 to calculate the number of occupants including a driver and passengers. The result of summation at the adder 413 is used as the calculated number of occupants and transmitted via a vehicle bus 410 such as a CAN bus and so on under control of a bus controller (e.g. a CAN transceiver) 409 via a bus controller interface 408 and used for determining the current vehicle configuration status for toll collection. The current vehicle configuration status for toll collection is transmitted to an external device such as a toll collection information receiver via an antenna module 412 by the transponder 407. At the same time, the current vehicle configuration status for toll collection is indicated at the toll configuration indicator 406.

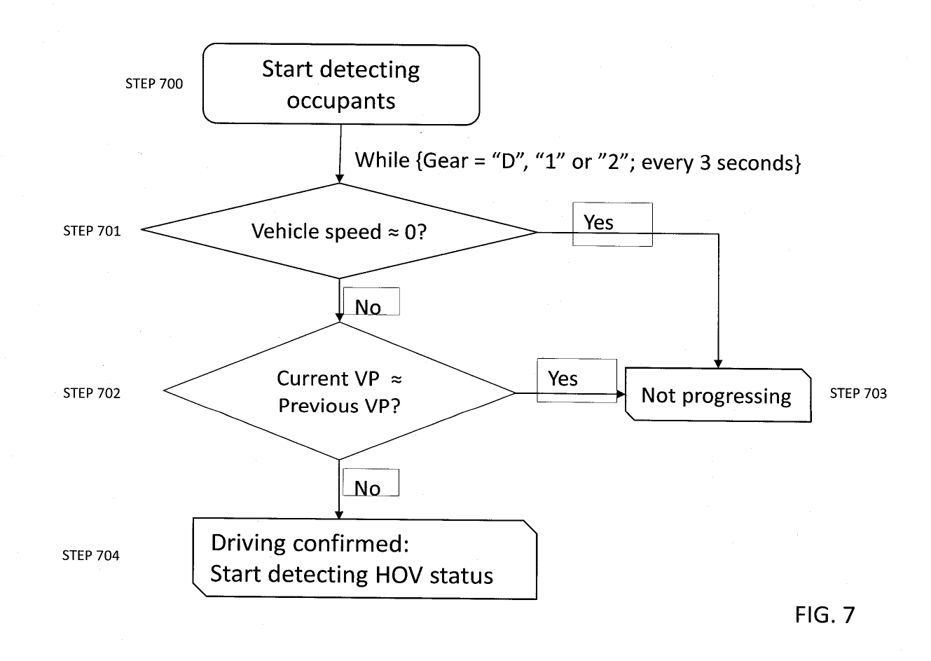

As described above, if the status is related to the number of passengers in the vehicle, such information may be obtained by a plurality of weight sensors embedded in seats, body temperature thermometers, seat belt sensors, cameras, or proximity sensors. In one embodiment, the plurality of sensors starts detecting occupants (STEP 700) as shown in FIG. 7. The occupancy detection may start when a driver starts driving. While a gear position is at either “D”, “1” or “2”, a vehicle speed is detected (STEP 701) every predetermined period, (i.e. three seconds). If the vehicle speed detected is almost zero, it is determined that the vehicle is not progressing (STEP 703) and the occupancy detection is not started. Also, if a current vehicle position obtained from GPS or any vehicle position detecting device is almost identical to a previous vehicle position obtained from GPS or any vehicle position detecting device (STEP 702), it is determined that the vehicle is not progressing (STEP 703) and the occupancy detection is not started. If the vehicle speed is detected and the detected vehicle position information shows there is a difference between the previous vehicle position and the current vehicle position, the vehicle is considered progressing and a driving status is confirmed. Upon confirmation of the driving status, detection of a number of occupants to be used for determining high-occupancy vehicle (HOV) status starts (STEP 704).

Alternatively, the plurality of sensors may start detecting the number of occupants when the vehicle is determined to be approaching to a toll booth or when the vehicle's transponder starts communicating with a toll collection information receiver at the toll booth.

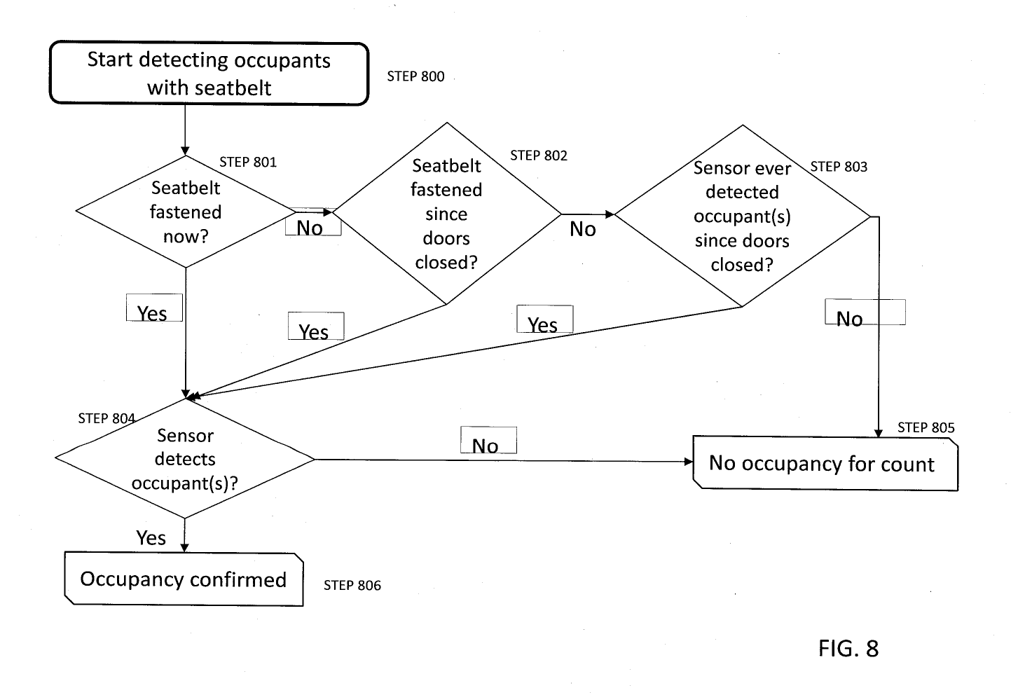

In one embodiment, the detection of the occupants may use seat belt sensors indicating current and past fastening statuses. FIG. 8 shows a process flow of the detection of the occupants primarily using the seat belt sensors. Once the process detecting occupants starts (STEP 800), it is determined for each seat belt sensor whether the seat belt fastening is detected (STEP 801). If any of the seat belts is currently fastened, each seat belt sensor or other sensor or a combination of these sensors detects occupants (STEP 804). If the result is affirmative, the occupancy is confirmed (STEP 806). If the result in STEP 804 is negative, no occupancy is counted (STEP 805). If there is no seat belt currently detected to be fastened in STEP 801, a history of seatbelt status since the vehicle doors are closed is analyzed (STEP 802). If the fastening of any seat belt since the doors are closed is confirmed in the history, the detection of occupants is conducted (STEP 804). If the result of STEP 802 is negative, a history of any sensor detected any occupant since the doors are closed is analyzed (STEP 803). If the detection of any occupant by any sensor since the doors are closed is found in the history, the detection of occupants is conducted (STEP 804). If the result of STEP 802 is negative, it is determined that no occupancy is counted (STEP 805).

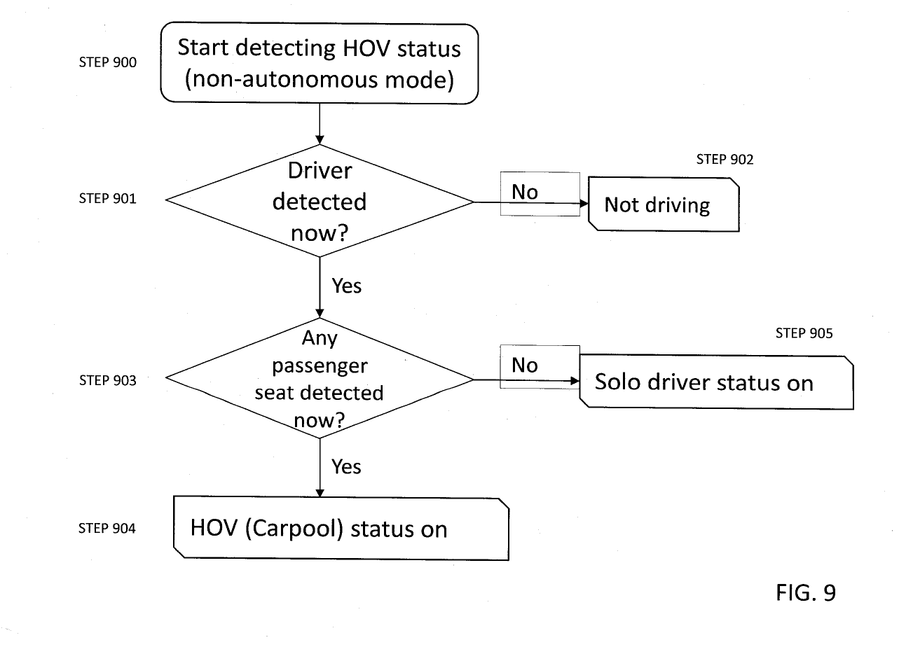

Based on the detection of the occupants, whether the vehicle is considered a high-occupancy vehicle (HOV) is determined. FIG. 9 shows one embodiment of such detection in a non-autonomous mode. Once a detection process of HOV status starts (STEP 900), detection of a driver on a driver seat is executed first (STEP 901). If no one is detected on the driver seat, it is considered that the vehicle is not a driving status (STEP 902). The driver is detected on the driver seat, detection of any passenger currently on any passenger seat is executed (STEP 903). If the detection of passenger is affirmative, HOV (carpool) status is activated (STEP 904). If the detection of passenger is negative, a solo driver status is alternatively activated (STEP 905).

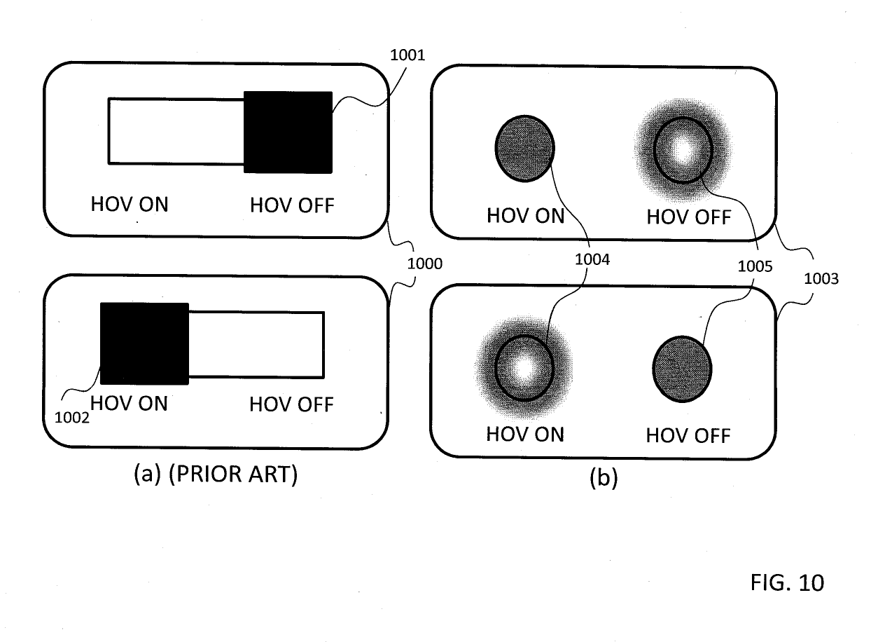

The result can be indicated on a toll configuration indicator of a transponder. A conventional system as illustrated in FIG. 10(a) merely allows a user to switch between HOV status OFF 1001 and HOV status ON 1002 of the toll configuration indicator 1000. In contrast, one embodiment of the toll configuration indicators 1003 illustrated in FIG. 10 (b) allows a user to obtain a feedback from the transponder regarding an HOV status. If the HOV status is not activated (=OFF), HOV ON status light 1004 is not turned on and HOV OFF status light 1005 is lit as shown above. On the other hand, if the HOV status is activated (=ON), HOV ON status light 1004 is turned on and HOV OFF status light 1005 is turned off as shown below. Thus, the user does not need to switch between ON and OFF of HOV status and a correct HOV status can be transmitted to a toll collection information receiver automatically and this prevents the user from not setting a right HOV status.

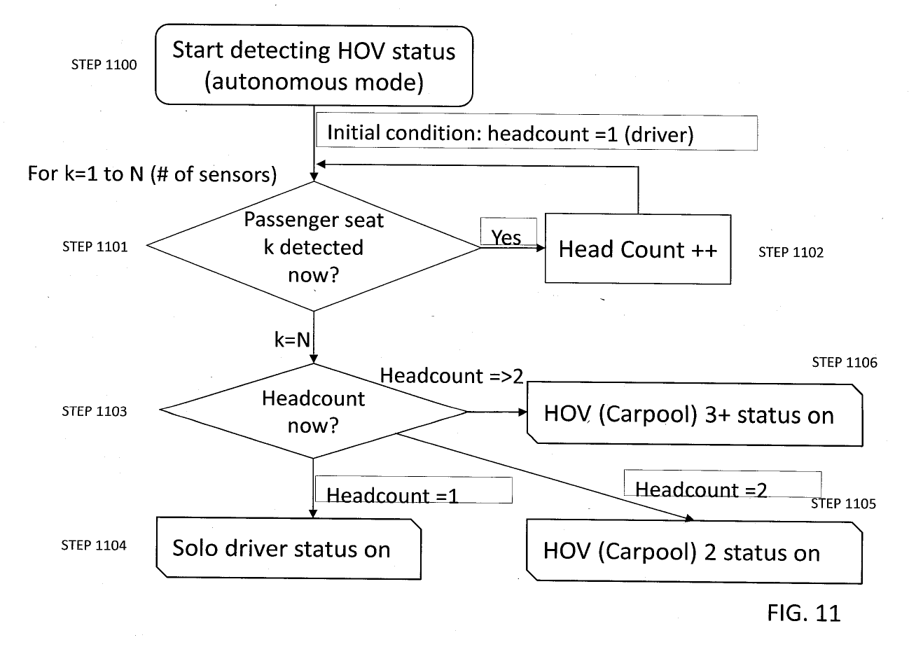

Alternatively, in another embodiment, whether the vehicle's HOV status can be determined for a plurality of passengers in an autonomous mode shown in FIG. 11. In the beginning of a detection process of HOV status, an initial condition sets a head-count as one including a driver. Once the detection process of HOV status starts (STEP 1100), detection of a passenger currently on each passenger seat is executed (STEP 1101). If each detection step of passenger is affirmative, the detection is considered for a head-count (STEP 1102). This passenger detection is executed for each sensor, thus this detection is repeated for a number of sensors. After the repetition of the passenger detection steps is completed, the head-count is determined as a number of occupants (STEP 1103). If the number of passengers is one, then a solo driver status is activated (STEP 1104). If the number of passengers is two, an HOV (carpool) 2 status is activated (STEP 1105). If the number of passengers is two, an HOV (carpool) 3+ status is activated (STEP 1106).

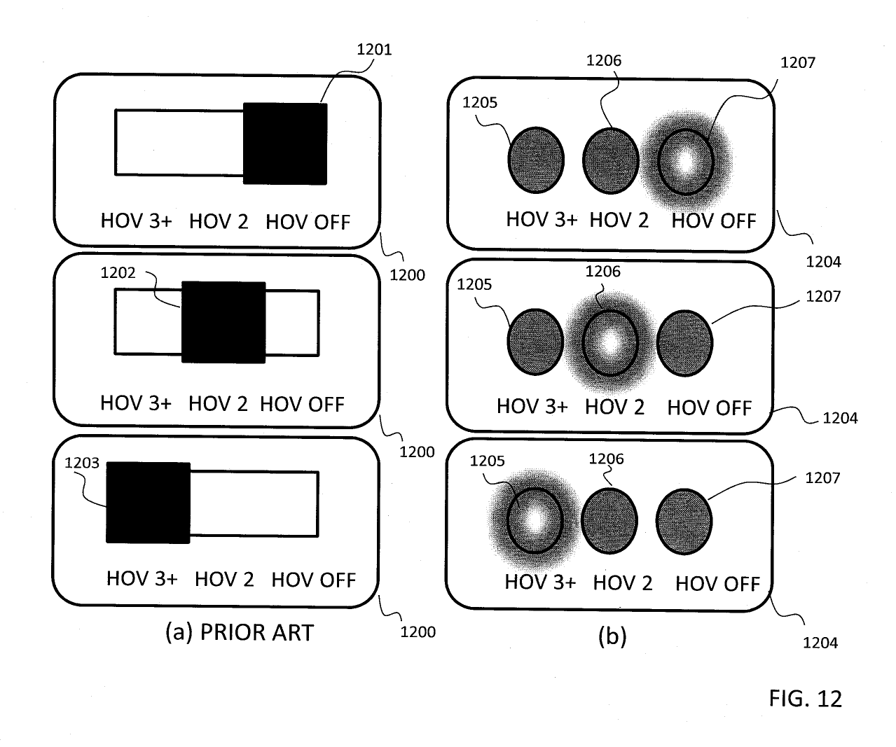

The result can be indicated on a toll configuration indicator of a transponder. A conventional system as illustrated in FIG. 12(a) merely allows a user to switch among HOV status OFF 1201, HOV 2 status 1202 for indicating two occupants in a vehicle and HOV 3+ status 1203 for indicating three or more occupants in the vehicle, of the toll configuration indicator 1200. In contrast, one embodiment of the toll configuration indicators 1204 illustrated in FIG. 12(b) allows a user to obtain a feedback from the transponder regarding an HOV status. If the HOV status is not activated (=OFF), HOV 3+ status light 1205 and HOV 2 status light 1206 are turned off and HOV OFF status light 1207 is lit as shown above. If the HOV status is determined that there are only two occupants in the vehicle, HOV 3+ status light 1205 and HOV OFF status light 1207 are turned off and HOV 2 status light 1206 is lit as shown in the middle. On the other hand, if the HOV status is determined that there are three or more occupants in the vehicle, HOV 2 status light 1206 and HOV OFF status light 1207 are turned off and HOV 3+ status light 1205 is lit as shown below. Thus, the user does not need to switch between HOV 3+, HOV 2 and HOV OFF of HOV status and a correct HOV status can be transmitted to a toll collection information receiver automatically and this prevents the user from not setting a right HOV status.

Although this invention has been disclosed in the context of certain preferred embodiments and examples, it will be understood by those skilled in the art that the inventions extend beyond the specifically disclosed embodiments to other alternative embodiments and/or uses of the inventions and obvious modifications and equivalents thereof. In addition, other modifications which are within the scope of this invention will be readily apparent to those of skill in the art based on this disclosure. It is also contemplated that various combination or sub-combination of the specific features and aspects of the embodiments may be made and still fall within the scope of the inventions. It should be understood that various features and aspects of the disclosed embodiments can be combined with or substituted for one another in order to form varying mode of the disclosed invention. Thus, it is intended that the scope of at least some of the present invention herein disclosed should not be limited by the particular disclosed embodiments described above.

1. A method of communicating information regarding a number of occupants in a vehicle for an electronic toll collection system comprising at least one antenna at a toll lane entrance, the vehicle and a transponder in the vehicle, comprising:
detecting occupancy in the vehicle by at least one sensor in the vehicle;
computing a number of one or more occupants based on the detected occupancy by the at least one sensor;
setting one of a plurality of toll configurations based on the number of one or more occupants;
transmitting the one of the plurality of toll configurations and account information associated with the transponder to the antenna;
receiving the one of the plurality of toll configurations and the account information from the transponder, and charging a predetermined toll amount on an account corresponding to the received account information based on the one of the plurality of toll configurations from the transponder.

2. (canceled)

3. An electronic toll collection system configured to set a toll configuration based on a number of one or more occupants in a vehicle, comprising:
a transponder in the vehicle configured to set one of a plurality of toll configurations corresponding with the number of one or more occupants and to transmit the one of the plurality of toll configurations and account information associated with the transponder to the antenna; and
at least one antenna at an entrance of a toll lane configured to receive the one of the plurality of toll configurations and the account information from the transponder;
wherein the electronic toll collection system further comprises:
at least one sensor in the vehicle configured to detect occupancy in the vehicle; and
a processor configured to compute the number of one or more occupants based on the detected occupancy by the at least one sensor.

4. The electronic toll collection system of claim 3, wherein at least one sensor is an electric field sensor, a seat belt sensor or a combination thereof.

5. The electronic toll collection system of claim 3, wherein the transponder comprises the processor therein.

6. The electronic toll collection system of claim 5, wherein at least one sensor is coupled to the transponder via a vehicle bus.

7. The electronic toll collection system of claim 5, wherein at least one sensor is wirelessly coupled to the transponder.

8. The electronic toll collection system of claim 3, wherein the transponder is coupled to the processor via a vehicle bus.

9. The electronic toll collection system of claim 3, wherein the transponder is wirelessly coupled to the processor.

10. The electronic toll collection system of claim 8, wherein at least one sensor is coupled to the processor via a vehicle bus.

11. The electronic toll collection system of claim 9, wherein at least one sensor is wirelessly coupled to the processor.

12. A transponder in a vehicle for an electronic toll collection system configured to set a toll configuration based on a number of one or more occupants configured to set one of a plurality of toll configurations corresponding with a number of one or more occupants and to transmit the one of the plurality of toll configurations and account information associated with the transponder to the antenna,
wherein the transponder is configured to receive the number of one or more occupants from a processor as a result of computation based on the detected occupancy by at least one sensor in the vehicle.

13. The transponder of claim 12, wherein the at least one sensor is an electric field sensor, a seat belt sensor or a combination thereof.

14. The transponder of claim 12, wherein the transponder comprises the processor therein.

15. The transponder of claim 14, wherein at least one sensor is coupled to the transponder via a vehicle bus.

16. The transponder of claim 14, wherein at least one sensor is wirelessly coupled to the transponder.

17. The transponder of claim 12, wherein the transponder is coupled to the processor via a vehicle bus.

18. The transponder of claim 12, wherein the transponder is wirelessly coupled to the processor.

19. The transponder of claim 17, wherein at least one sensor is coupled to the processor via a vehicle bus.

20. The transponder of claim 18, wherein at least one sensor is wirelessly coupled to the processor.

21. The method of claim 1 for communicating information regarding a number of occupants in a vehicle for an electronic toll collection system, wherein the at least once sensor in the vehicle is an electric field sensor, a seat belt sensor or a combination thereof.
